(19) United States
(12) Patent Application Publication
(10) Pub. No.: US 2024/0177438 A1
(43) Pub. Date: May 30, 2024

(54) METHOD AND SYSTEM OF MODIFYING THREE-DIMENSIONAL MODEL OF FOOT TO CREATE MODIFIED THREE-DIMENSIONAL MODEL

(71) Applicant: Shoely Oy, Helsinki (FI)

(72) Inventors: Patrik Louko, Helsinki (FI); Jussi Kosola, Helsinki (FI)

(73) Assignee: Shoely Oy, Helsinki (FI)

(21) Appl. No.: 18/072,355

(22) Filed: Nov. 30, 2022

(51) Int. Cl. G06T 19/20; A43D 119/00; B29C 64/386; B33Y 50/00; B33Y 80/00

(52) U.S. Cl. CPC G06T 19/20; A43D 119/00; B29C 64/386; B33Y 50/00; B33Y 80/00; B29K 2023/083

(57) ABSTRACT

A method and a system for modifying a three-dimensional (3D) model to create a modified 3D model efficiently and accurately. The method includes obtaining the 3D model and identifying a first point that is a plantar head of 1. metatarsal, a second point that is a plantar head of 5. metatarsal, a third point that is a pternion, and an Achilles tendon center of coronal axis. Furthermore, defining a first straight line, a second straight line perpendicular to the first straight line and a third straight line that is perpendicular to the plane. Thereafter creating the modified 3D model by rotating and translating the heel part such that the second straight line passes through the third point (306), and the Achilles tendon is parallel to the third straight line.

### TECHNICAL FIELD

The present disclosure relates generally to the customization of the insole; and more specifically, to a method and a system of modifying a three-dimensional (3D) model of a foot to create a modified 3D model.

### BACKGROUND

Shoes with comfortable insoles are widely used to provide support and comfort to feet of a user. However, every user does not have identically shaped feet due to various medical conditions, such as club foot, flat foot, fused toes, and the like. Therefore, customized insoles are used to match every user's foot. The customized insoles are used for a number of purposes, such as daily wear comfort, height enhancement, plantar fasciitis treatment, arch support, foot and joint pain relief from arthritis, and orthopaedic correction.

Conventionally in certain scenarios, the customized insoles are manufactured by professional shoemakers, physiotherapists, or podiatrists. In such scenarios, the user is required to stand on a moulding material, or a scanner is used to obtain a shape and a size of the feet for the manufacturing of the customized insoles. However, such conventional scenarios require at least one professional to supervise a correct position of the foot. Without a professional guidance, it is difficult to obtain a suitable 3D model scan of a foot for producing a customized insole. As a result, the manufactured customized shoes and insoles are misaligned, due to which the shoes fail to provide comfort and support, which is not desirable.

Therefore, in light of the foregoing discussion, there exists a need to overcome the drawbacks in the conventional methods for creating a three-dimensional (3D) model of the foot that is required for the manufacturing of the customized insoles.

### SUMMARY OF THE INVENTION

The present disclosure seeks to provide a method and a system of modifying a three-dimensional (3D) model of a foot to create a modified 3D model. The present disclosure also seeks to provide a system for modifying a 3D model of a foot to create a modified 3D model. An aim of the present disclosure is to provide a solution that overcomes at least partially the problems encountered in the prior art and provides an improved method and an improved system for modifying the 3D model of the foot to create the modified 3D model.

In one aspect, an embodiment of the present disclosure provides a method of modifying a 3D model of a foot to create a modified 3D model, the method comprising:
obtaining the 3D model of the foot;
identifying from the 3D model
   a first point corresponding to a plantar head of 1. metatarsal,
   a second point corresponding to a plantar head of 5. metatarsal,
   a third point corresponding to a pternion;
   an Achilles tendon center of coronal axis;
defining
   a first straight line passing via the first point and the second point;
   a second straight line perpendicular to the first straight line and passing via the second point, the second straight line having direction parallel to a plane defined by the first point, the second point, and the third point;
   a third straight line being perpendicular to the plane and passing via the third point;
dividing the 3D model to a heel part and a toe part, wherein the heel part comprises from 30% up to 70% of the total foot in direction of the second straight line;
creating the modified 3D model by
   rotating and translating the heel part in a way that the second straight line passes via the third point, wherein the rotation and translation is parallel to the plane, and
   rotating the heel part in a way that the Achilles tendon is parallel to the third straight line.

In another aspect, an embodiment of the present disclosure provides a method of manufacturing an insole, wherein the insole is manufactured based on a modified 3D model, wherein the modified 3D model is created according to the method of modifying a 3D model of a foot to create a modified 3D model.

In yet another aspect, an embodiment of the present disclosure provides a method of fabrication of a shoe midsole having a custom shape and a custom support profile, wherein the shoe midsole is fabricated based on a modified 3D model by using one of: an injection molding of ethylene vinyl acetate (EVA), three-dimensional (3D) printing or milling of midsole materials, wherein the modified 3D model is created according to the method of modifying a 3D model of a foot to create a modified 3D model.

In another aspect, an embodiment of the present disclosure provides a system for modifying a 3D model of a foot to create a modified 3D model, the system comprising:
an image-capture device configured to capture a 3D model of the foot; and
a processor configured to:
   obtain the 3D model of the foot from the image-capture device;
   identify from the 3D model:
      a first point corresponding to a plantar head of 1. metatarsal,
      a second point corresponding to a plantar head of 5. metatarsal
      a third point corresponding to a pternion;
      an Achilles tendon center of coronal axis;
   define:
      a first straight line passing via the first point and the second point;
      a second straight line perpendicular to the first straight line and passing via the second point, the second straight line having direction parallel to a plane defined by the first point, the second point, and the third point;
      a third straight line being perpendicular to the plane and passing via the third point;
   divide the 3D model to a heel part and a toe part, wherein the heel part comprises from 30% up to 70% of the total foot in direction of the second straight line; and
   create the modified 3D model by:
      rotating and translating the heel part in a way that the second straight line passes via the third point, wherein the rotation and translation is parallel to the plane, and
      rotating the heel part in a way that the Achilles tendon center of coronal axis is parallel to the third straight line.

Embodiments of the present disclosure substantially eliminate or at least partially address the aforementioned problems in the prior art and provide an efficient, effective, and accurate method for modifying the 3D model of the foot to create the modified 3D model.

Additional aspects, advantages, features, and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart that includes steps involved in a method of modifying a three-dimensional (3D) model of a foot to create a modified three-dimensional (3D) model, in accordance with an embodiment of the present disclosure;

FIG. 2 is a block diagram of a system for modifying a three-dimensional (3D) model of a foot to create a modified 3D model, in accordance with an embodiment of the present disclosure;

FIG. 3 is an exemplary diagram that represents an identification of various parts, in accordance with an embodiment of the present disclosure;

FIG. 4 is an exemplary diagram that represents an identification of a first point, a second point, and a third point, in accordance with an embodiment of the present disclosure;

FIG. 5 is an exemplary diagram that represents a first straight line, a second straight line, and a third straight line on a plane, in accordance with an embodiment of the present disclosure;

FIG. 6A is an exemplary diagram that represents a re-alignment of a position of the foot according to natural position of a foot, in accordance with an embodiment of the present disclosure;

FIG. 6B is an exemplary diagram that represents a rotation of heel part in a way that the Achilles tendon is parallel to the third straight line, in accordance with an embodiment of the present disclosure;

FIG. 7A and FIG. 7B are exemplary diagrams that collectively represent a creation of a three-dimensional (3D) model of a foot of a human subject, in accordance with different embodiments of the present disclosure; and

FIG. 8 is an exemplary diagram that represents an insole that is manufactured after a modification of a three-dimensional (3D) model, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method of modifying a 3D model of a foot to create a modified 3D model, the method comprising:
obtaining the 3D model of the foot;
identifying from the 3D model
   a first point corresponding to a plantar head of 1. metatarsal,
   a second point corresponding to a plantar head of 5. metatarsal,
   a third point corresponding to a pternion;
   an Achilles tendon center of coronal axis;
defining
   a first straight line passing via the first point and the second point;
   a second straight line perpendicular to the first straight line and passing via the second point, the second straight line having direction parallel to a plane defined by the first point, the second point, and the third point;
   a third straight line being perpendicular to the plane and passing via the third point;
dividing the 3D model to a heel part and a toe part, wherein the heel part comprises from 30% up to 70% of the total foot in direction of the second straight line;
creating the modified 3D model by
   rotating and translating the heel part in a way that the second straight line passes via the third point, wherein the rotation and translation is parallel to the plane, and
   rotating the heel part in a way that the Achilles tendon is parallel to the third straight line.

In another aspect, an embodiment of the present disclosure provides another method of manufacturing an insole, wherein the insole is manufactured based on a modified 3D model, wherein the modified 3D model is created according to the method of modifying a 3D model of a foot to create a modified 3D model.

In yet another aspect, an embodiment of the present disclosure provides yet another method of fabrication of a shoe midsole having a custom shape and a custom support profile, wherein the shoe midsole is fabricated based on a modified 3D model by using one of an injection molding of ethylene vinyl acetate (EVA), three-dimensional (3D) printing or milling of midsole materials, wherein the modified 3D model is created according to the method of modifying a 3D model of a foot to create a modified 3D model.

In another aspect, an embodiment of the present disclosure provides a system for modifying a 3D model of a foot to create a modified 3D model, the system comprising:
an image-capture device configured to capture a 3D model of the foot; and
a processor configured to:
   obtain the 3D model of the foot from the image-capture device;
   identify from the 3D model:
      a first point corresponding to a plantar head of 1. metatarsal,
      a second point corresponding to a plantar head of 5. metatarsal
      a third point corresponding to a pternion;
      an Achilles tendon center of coronal axis;
   define:
      a first straight line passing via the first point and the second point;
      a second straight line perpendicular to the first straight line and passing via the second point, the second straight line having direction parallel to a plane defined by the first point, the second point, and the third point;
      a third straight line being perpendicular to the plane and passing via the third point;
   divide the 3D model to a heel part and a toe part, wherein the heel part comprises from 30% up to 70% of the total foot in direction of the second straight line; and
   create the modified 3D model by:
      rotating and translating the heel part in a way that the second straight line passes via the third point, wherein the rotation and translation is parallel to the plane, and
      rotating the heel part in a way that the Achilles tendon center of coronal axis is parallel to the third straight line.

The present disclosure provides an improved method and an improved system for modifying the 3D model of the foot to create the modified 3D model. Furthermore, the present disclosure provides an improved method of manufacturing the insole and an improved method for the fabrication of the shoe midsole with a custom shape and a custom support profile. For the purposes of the present disclosure, the modification of the 3D model corresponds to the re-alignment of the 3D model of the foot that is obtained based on the natural position of the foot of the human subject. Moreover, the modified 3D model of the foot is used for manufacturing the insole and for the fabrication of the shoe midsole with customized shape and support profile to provide comfort and support to the foot of the human subject.

The method comprises obtaining the 3D model of the foot. The term “3D model” as used herein refers to a processed image as obtained after applying image processing techniques on the 3D image. In an example, the 3D image is obtained from the image capturing device. The 3D model of the foot is obtained by scanning the foot, such as during an active phase of gait. For example, scanning the foot to obtain the 3D model of the foot while the human subject is walking, running, or skiing. In one or more embodiments, the obtaining of the 3D model of the foot comprises segregating the foot from a ground surface. For example, the foot is placed on a floor or on any other surface on which the 3D scan of the foot in a toe-off position can be obtained. Moreover, the 3D model is obtained according to the natural position of the foot, such as the foot with a natural arch, or low arch or high arch, and the like.

In one or more embodiments, the 3D model is captured by using any one of a rotatable camera, a time-of-flight camera, an infra-red camera, and an optical camera. In an example, the 3D model is captured by using the rotatable camera. In another example, the 3D model is captured by using the time-of-flight camera. In yet another example, the 3D model is captured by using the infra-red camera. Similarly, the 3D model can be captured by using the optical camera. The 3D model of the foot is captured by scanning the foot, such as during an active phase of gait. As a result, the 3D model with improved quality and an improved resolution is captured by using any of the above-mentioned examples.

The method further comprises identifying the first point corresponding to the plantar head of the 1. metatarsal from the 3D model. The plantar head of the 1. metatarsal (i.e., 1^{st} metatarsal) from the 3D model is the lowest point of a ball of the foot that facilitates the human subject to walk. Moreover, the identification of the first point is used to obtain the shape of the foot. Furthermore, the method comprises identifying the second point corresponding to the plantar head of the 5. metatarsal from the 3D model. The plantar head of the 5. metatarsal (i.e., 5th metatarsal) is the longest bone of the foot that connects the little toe with the other part of the foot on the lateral side of the foot. In addition, the identification of the second point is also used to obtain the accurate length of the foot. Furthermore, the method comprises identifying the third point corresponding to a pternion from the 3D model. The pternion of the foot corresponds to a heel bone point that is located at the posterior centre point of the foot. Moreover, the third point is used to obtain the shape and structure of the foot.

The method further comprises identifying an Achilles tendon centre of coronal axis from the 3D model. The Achilles tendon connects calf muscles of a heel bone of the foot and facilitates the human to walk, run, and jump. Moreover, the identification of the Achilles tendon centre of the coronial axle from the 3D model is used to identify the foot angle that is further used to obtain the natural shape of the foot for the creation of the 3D model of the foot.

In one or more embodiments, the identifying step from the 3D model further comprises identifying whether the 3D model is of a left foot or a right foot of the human subject. The left foot is different in shape, size, and alignment from the right foot. For example, the right foot is slightly longer than the left foot. Thus, the identification of the left foot and the right foot of the human subject is used to capture a precise natural shape of the foot to further obtain the 3D model with reduced error.

In one or more embodiments, the identifying step from the 3D model further comprises identifying a medial side and a lateral side of the foot. The identification of the medial side and the lateral side of the foot is used to identify the side specific parts of the foot, such as the inner and the outer shape of the foot. In one or more embodiments, the identifying step from the 3D model further comprises identifying a medial malleolus portion and a lateral malleolus portion of the foot. The lateral malleolus refers to the bone that is located at the outer side of an ankle joint of the foot and the medial malleolus refers to the bone that is located at the inner side of the ankle of the foot. Moreover, identification of the medial malleolus portion and the lateral malleolus portion provides the improved and accurate 3D model that is obtained on the basis of the natural position of the foot of the human subject.

In one or more embodiments, the identifying step from the 3D model further comprises identifying a toe. As the size of the toe of every human subject may differ due to number of medical conditions, such as swelling, instability in forefoot, and the like. In certain cases, the toe of the human subject can be broken, such as due to accident or other causes. Therefore, the identification of the toe is used to determine the accurate size and shape of the 3D model, which is used to improve the comfort level of the human subject. In one or more embodiments, the identifying step from the 3D model further comprises identifying one or more metatarsal head joints of the foot. The one or more metatarsal head joints of the foot connect a phalangeal bone (or a phalanx) with a metatarsal bone (or a long bone) of the foot. In certain cases, the size of the one or more metatarsal head joints may be reduced, such as due to accident or other causes. Therefore, an accurate identification of the one or more metatarsal plantar head joints of the foot is used to obtain the 3D model of the foot based on the shape of the front part of the foot of the human subject.

The method further comprises defining a first straight line passing via the first point and the second point. In an implementation, the first straight line is passed via the plantar head of the 1. metatarsal and the plantar head of the 5. Metatarsal. Moreover, the first straight line horizontally divides the foot into two parts that are further used to re-align the foot. Furthermore, the method comprises defining a second straight line perpendicular to the first straight line and passing via the second point.

Moreover, the direction of the second straight line is parallel to a plane defined by the first point, the second point, and the third point. In an implementation, the second straight line is perpendicular to the first straight line that passes through the plantar head of the 1. metatarsal and the plantar head of the 5. metatarsal. The method further comprises defining the third straight line that is perpendicular to the plane and passing via the third point that is the pternion of the foot. The third straight line is used to resolve the problem of misalignment of the points in the 3D model, such as the plantar head of the 1. metatarsal, the plantar head of the 5. metatarsal, and the pternion of the foot by the identification of the accurate location of the points to further modify the 3D model. The method further comprises dividing the 3D model into a heel part and a toe part. Moreover, the heel part comprises 30% to 70% of the total foot in direction of the second straight line. The foot is divided into two parts, such as the heel part and the toe part and each part is re-aligned separately to obtain the accurate 3D scan of the natural position of the foot.

Furthermore, the method comprises creating the modified 3D model by rotating and translating the heel part in a way that the second straight line passes via the third point. Moreover, the rotation and translation of the heel part is parallel to the plane. In an implementation, the modified 3D model is created manually by passing the second straight line via the third point. In another implementation, the modified 3D model is created by using artificial intelligence or machine learning algorithms. The method further comprises creating the modified 3D model by rotating the heel part in a way that the Achilles tendon is parallel to the third straight line. The rotation of the heel part according to the Achilles tendon is used to re-align the 3D model of the foot accurately according to the natural position of the human subject. In one or more embodiments, the creating of the modified 3D model comprises modifying a lateral arch of the foot in such a way that the lateral arch is lowered towards a ground surface in a standing position of the foot when the foot has a concave lateral arch or a cavus foot. The lateral arch is lowered towards the ground surface to provide flexible lateral arches according to the shape and size of the foot. In addition, the lateral arch is lowered to provide more comfort and support if the human subject is suffering from the medical deformities, such as the concave lateral arch, cavus foot, and the like.

In the present disclosure, another method is used for manufacturing an insole. Moreover, the insole is manufactured based on the modified 3D model. The modified 3D model is created according to the method for modifying the 3D model. The insoles are manufactured according to the shape and the size of the foot of the human subject accurately and efficiently to improve the comfort and support level for the human subject.

In the present disclosure, yet another method is used for the fabrication of a shoe midsole including a custom shape and a custom support profile. Moreover, the shoe midsole is fabricated based on the modified 3D model by using an injection molding of ethylene vinyl acetate (EVA), three-dimensional (3D) printing, or milling of midsole materials. In an example, the shoe midsole is fabricated based on the modified 3D model by using the injection molding of the EVA. In another example, the shoe midsole is fabricated based on the 3D printing. Similarly, the shoe midsole is fabricated based on the milling of midsole material, such as leather, foam rubbers, cellular polymers, and the like.

In the present disclosure, the system is used for modifying the 3D model of the foot to create the modified 3D model. The modification of the 3D model of the foot corresponds to the re-alignment of the 3D model based on the natural position of the foot of the human subject.

The system comprises the image-capture device that is configured to capture the 3D model of the foot. The 3D model of the foot is captured by scanning the foot, such as during an active phase of gait. For example, scanning the foot to obtain the 3D model of the foot while the human subject is walking, running, or skiing.

In one or more embodiments, the image-capture device is any one of a rotatable camera, a time of flight camera, an infra-red camera, and an optical camera. In an example, the 3D model is captured by using the rotatable camera. In another example, the 3D model is captured by using the time of flight camera. In yet another example, the 3D model is captured by using the infra-red camera. Similarly, the 3D model can be captured by using the optical camera. As a result, the 3D model with an improved quality and an improved resolution is captured by using any of the above-mentioned examples.

The system further comprises the processor that is configured to obtain the 3D model of the foot from the image-capture device. Example of the processor may include but is not limited to a controller, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry. Firstly, the image-capture device is configured to capture the 3D model. Thereafter, the captured 3D model is further obtained by the processor that is included in the system. Moreover, the processor is configured to identify the first point corresponding to a plantar head of 1. metatarsal from the 3D model. The plantar head of 1. metatarsal (i.e., 1st metatarsal) from the 3D model is the lowest point of a ball of the foot that facilitates the human subject to walk.

The processor is further configured to identify the second point corresponding to a plantar head of the 5. metatarsal from the 3D model. The plantar head of the 5. metatarsal (i.e., the 5^{th} metatarsal) is the longest bone of the foot that connects the little toe with the other part of the foot on the lateral side of the foot. In addition, the identification of the second point is also used to obtain the length of the foot effectively and efficiently with an improved accuracy. Furthermore, the processor is configured to identify the third point corresponding to pternion from the 3D model. The pternion of the foot corresponds to a heel bone point that is located at the posterior centre point of the foot. Moreover, the first point, the second point, and the third point are identified to locate the different parts of the foot, which is further used to obtain the natural position of the human subject.

The processor is further configured to identify the Achilles tendon center of coronal axis from the 3D model. The Achilles tendon connects calf muscles of a heel bone of the foot and facilitates the human to walk, run, and jump. Moreover, the identification of the Achilles tendon centre of the coronial axle from the 3D model is used to identify the foot angle that is further used to obtain the natural shape of the foot for the creation of the 3D model of the foot. In one or more embodiments, the identification of from the 3D model further includes identifying a medial malleolus portion and a lateral malleolus portion of the foot. The lateral malleolus refers to the bone that is located at the outer side of an ankle joint of the foot and the medial malleolus refers to the bone that is located at the inner side of the ankle of the foot. As a result, the identification step from the 3D model is used to identify the efficient and accurate natural position of the foot of the human subject.

In one or more embodiments, the identification from the 3D model further includes identifying one or more metatarsal head of the foot. The one or more metatarsal head joints of the foot connects a phalangeal bone (or a phalanx) with a metatarsal bone (or a long bone) of the foot. As a result, the identification of the one or more metatarsal plantar head joints of the foot provides the identification of the one or more metatarsal head joints of the foot and is used to obtain the accurate shape of the front part of the foot of the human subject.

The processor is further configured to define the first straight line passing via the first point and the second point. In an implementation, the first straight line is passed via the plantar head of the 1. metatarsal and the plantar head of the 5. metatarsal. The first straight line horizontally divides the foot into two parts that are further used to re-align the foot. Thereafter, the processor is configured to define the second straight line perpendicular to the first straight line and passing via the second point, the second straight line having direction parallel to a plane defined by the first point, the second point, and the third point. In an implementation, the second straight line is perpendicular to the first straight line that passes through the head of the 1. metatarsal and the head of the 5. metatarsal. As a result, an improved and accurate 3D model of the foot is obtained according to the natural position of the foot of the human subject.

The processor is configured to define the third straight line being perpendicular to the plane and passing via the third point. The third straight line is used to resolve the problem of misalignment of the points in the 3D model, such as the plantar head of the 1. metatarsal, the plantar head of the 5. metatarsal, and the pternion of the foot by the identification of the accurate location of the points to further modify the 3D model. Thereafter, the processor is configured to divide the 3D model into a heel part and a toe part. Moreover, the heel part comprises from 30% up to 70% of the total foot in direction of the second straight line. The foot is divided into two parts, such as the heel part and the toe part and each part is re-aligned separately to obtain the accurate 3D scan of the natural position of the foot. The processor is further configured to create the modified 3D model by rotating and translating the heel part in a way that the second straight line passes via the third point. Moreover, the rotation and translation of the heel part is parallel to the plane and rotating the heel part in a way that the Achilles tendon center of coronal axis is parallel to the third straight line. In an implementation, the modified 3D model is created manually by passing the second straight line via the third point. In another implementation, the modified 3D model is created by using artificial intelligence or machine learning algorithms. The processor is further configured to create the modified 3D model by rotating the heel part in a way that the Achilles tendon is parallel to the third straight line. The rotation of the heel part according to the Achilles tendon is used to re-align the 3D model of the foot accurately according to the natural position of the human subject.

In one or more embodiments, the creating of the modified 3D model includes modifying a lateral arch of the foot in a way that the lateral arch is lowered towards a ground surface in a standing position of the foot when the foot is detected with a concave lateral arch or a cavus foot. The lateral arch is lowered towards the ground surface to provide flexible lateral arches according to the shape and size of the foot. In addition, the lateral arch is lowered to provide more comfort and support if the human subject is suffering from the medical deformities, such as the concave lateral arch, cavus foot, and the like.

### DETAILED DESCRIPTION OF THE DRAWINGS

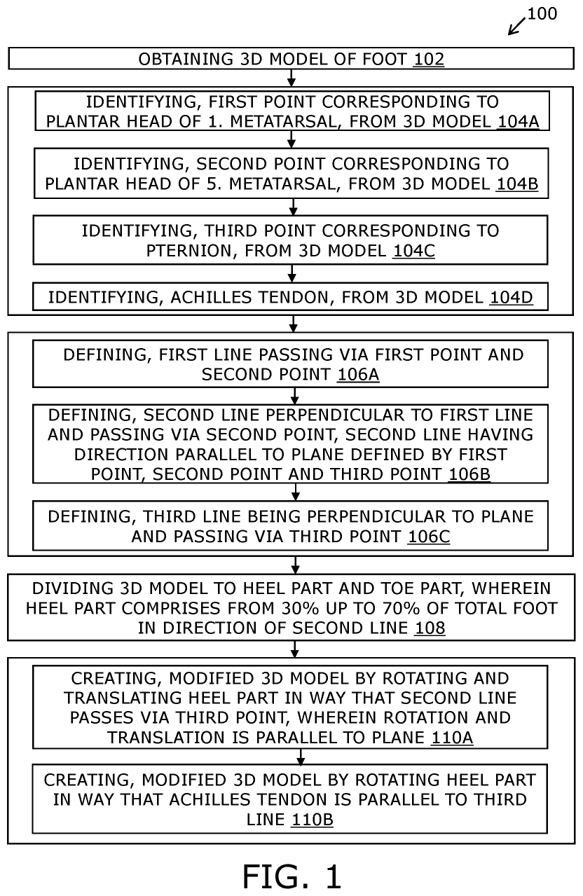

Referring to FIG. 1, illustrated a flowchart that includes steps involved in a method 100 of modifying a three-dimensional (3D) model of a foot to create a modified 3D model, in accordance with an embodiment of the present disclosure. At step 102, the method 100 comprises obtaining the 3D model of the foot. Thereafter, at step 104A, the method 100 comprises identifying a first point corresponding to a plantar head of 1. metatarsal. Furthermore, at step 104B, the method 100 comprises identifying a second point corresponding to a plantar head of 5. metatarsal. After that, at step 104C, the method 100 comprises identifying a third point corresponding to a pternion. In addition, at step 104D, the method 100 comprises identifying an Achilles tendon centre of coronal axis from the 3D model. Moreover, at step 106A, the method 100 comprises defining a first straight line passing via the first point and the second point. At step 106B, the method 100 comprises defining a second straight line perpendicular to the first straight line and passing via the second point. Moreover, the second straight line having direction parallel to a plane defined by the first point, the second point, and the third point. After that, at step 106C, the method 100 comprises defining a third straight line being perpendicular to the plane and passing via the third point. In addition, at step 108, the method 100 comprises dividing the 3D model into a heel part and a toe part. Moreover, the heel part includes 30% to 70% of the total foot in direction of the second straight line. Furthermore, at step 110A, the method 100 comprises creating the modified 3D model by rotating and translating the heel part in a way that the second straight line passes via the third point. Moreover, the rotation and translation are parallel to the plane. Finally, at step 110B, the method 100 comprises creating the modified 3D model by rotating the heel part in a way that Achilles tendon is parallel to the third straight line.

It may be appreciated that the steps 102 to 110B are only illustrative, and other alternatives can also be provided where one or more steps are added, one or more steps are removed, or one or more steps are provided in a different sequence without departing from the scope of the present disclosure.

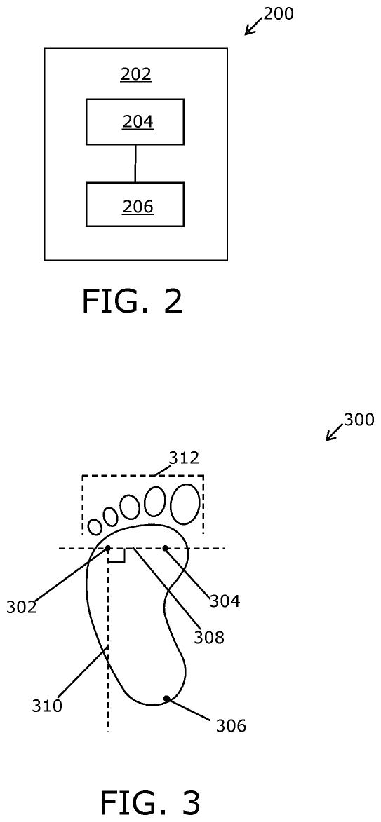

Referring to FIG. 2, illustrated is a block diagram 200 of a system 202 for modifying a three-dimensional (3D) model of a foot to create a modified 3D model, in accordance with an embodiment of the present disclosure. As shown, the system 202 includes an image-capture device 204 that is configured to capture the 3D model of the foot. The system 202 further includes a processor 206 that is configured to obtain the 3D model of the foot from the image-capture device 204. The processor 206 is further configured to identify a first point corresponding to a plantar head of 1. Metatarsal, a second point corresponding to a plantar head of 5. Metatarsal, a third point corresponding to a pternion, and an Achilles tendon center of coronal axis from the 3D model. The processor 206 is further configured to define a first straight line passing via the first point and the second point, a second straight line perpendicular to the first straight line and passing via the second point. Moreover, the second straight line is in the direction parallel to a plane defined by the first point, the second point, and the third point. Furthermore, the processor 206 is configured to define a third straight line that is perpendicular to the plane and passes via the third point and divide the 3D model into a heel part and a toe part. Moreover, the heel part includes 30% to 70% of the total foot in direction of the second straight line. Finally, the processor 206 is configured to create the modified 3D model by rotating and translating the heel part in a way that the second Straight line passes via the third point. Moreover, the rotation and translation are parallel to the plane. In addition, the processor 206 is configured to create the modified 3D model by rotating the heel part in a way that the Achilles tendon is parallel to the third straight line to provide an accurate modified 3D model of the foot of the human subject.

Referring to FIG. 3, illustrated is an exemplary diagram that represents an identification of various points of a foot, in accordance with an embodiment of the present disclosure. With reference to FIG. 3, there is shown a exemplary diagram 300 that represents a captured scanned image of the foot of the human subject. The processor 206 of FIG. 2 is configured to identify from the 3D model, a first point 302 corresponding to a plantar head of 1. Metatarsal, a second point 304 corresponding to a plantar head of 5. Metatarsal, a third point 306 corresponding to a pternion, and an Achilles tendon center of coronal axis. Furthermore, the processor 206 of FIG. 2 is further configured to define, from the 3D model, a first straight line 308 that passes through the first point 302 and the second point 304. Thereafter, a second straight line 310 is defined, which is perpendicular to the first straight line 308, and passes through the second point 304. In addition, a toe 312, a lateral side, and a medial side of the foot are also identified. Thus, the identification of the different parts of the foot is used to obtain an accurate and natural position of the foot of the human subject.

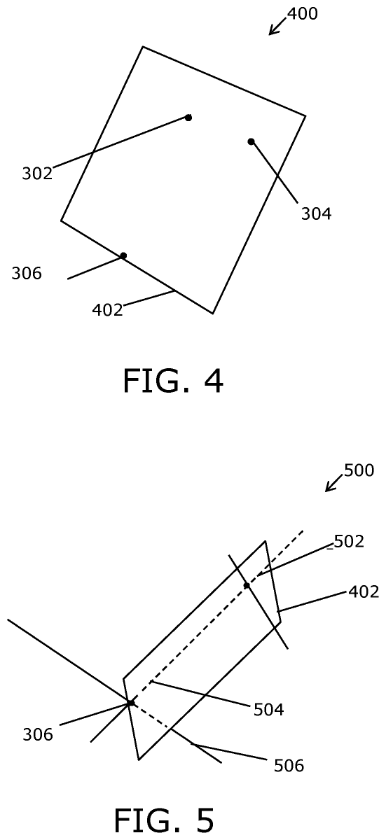

Referring to FIG. 4, illustrated is an exemplary diagram that represents an identification of a first point, a second point, and a third point on a plane, in accordance with an embodiment of the present disclosure. With reference to the FIG. 4, there is shown a plane 402 that represents the first point 302, the second point 304, and the third point 306. Moreover, the plane 402 is defined by using the processor 206 of FIG. 2 that is configured for modifying a three-dimensional (3D) model of the foot to create the modified 3D model. Thus, the modified 3D model is used to manufacture customized insoles to provide comfort and support to the human subject.

Referring to FIG. 5, illustrated is an exemplary diagram that represents a first straight line, a straight second line, and a straight third line on a plane, in accordance with an embodiment of the present disclosure. With reference to the FIG. 5, there is shown the plane 402 of FIG. 4, which represents a first straight line 502 that is defined by passing via the first point and the second point. There is further shown a second straight line 504 that is perpendicular to the first straight line 502 and passes through the second point. The second straight line 504 is in a direction parallel to the plane 402 that is defined by the first point, the second point, and the third point. Moreover, there is shown a third straight line 506 that is perpendicular to the plane 402 and passes through the third point. Therefore, the 3D model that is obtained through an image-capture device is modified by re-aligning the 3D model according to the natural position of the foot. Furthermore, the modified 3D model is used to manufacture customized insoles to provide comfort and support to the human subject.

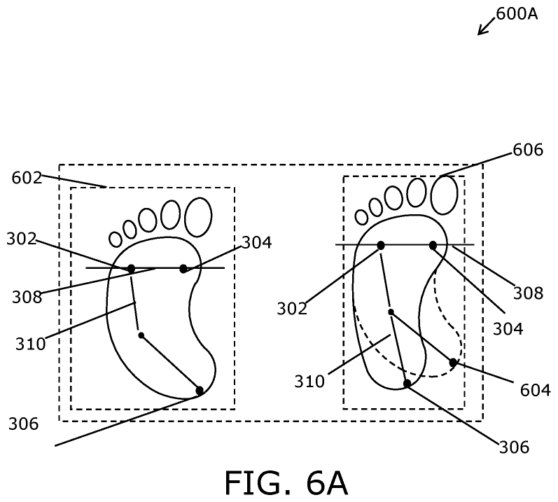

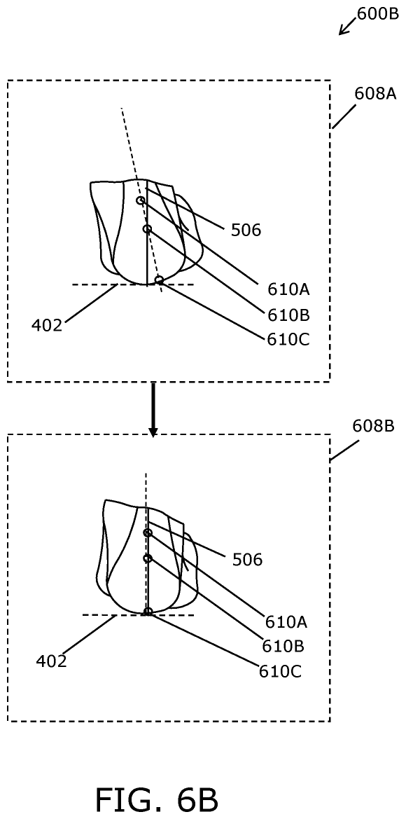

Referring to FIG. 6A, illustrated is an exemplary diagram that represents a scenario 600A of a re-alignment of a position of the foot according to the natural position of the foot, in accordance with an embodiment of the present disclosure. Firstly, a raw 3D scan 602 of a foot of a human subject is captured, such as by an image-capture device. Thereafter, the first point 302 that is a plantar head of 1. metatarsal, the second point 304 that is a plantar head of 5. metatarsal, the third point 306 that is a pternion, and an Achilles tendon centre of coronal axis is identified. After that, the raw 3D scan 602 is aligned through the first straight line 308 and the second straight line 310. Moreover, the first straight line 308 is passed via the first point 302 and the second point 304, and the second straight line 310 is perpendicular to the first straight line 308 and passes via the second point 304. The second straight line 310 is in a direction parallel to a plane that is defined by the first point 302, the second point 304, and the third point 306. Finally, a modified 3D model 606 with re-aligned point 604 is obtained by the re-alignment of the 3D model and based on the natural position of the foot, as shown in FIG. 6A. In other words, the modified 3D model 606 is an improved model of the foot.

FIG. 6B is an exemplary diagram that represents a rotation of heel part in a way that the Achilles tendon is parallel to the third straight line, in accordance with an embodiment of the present disclosure. With reference to the FIG. 6B, there is shown a scenario 600B that represents a rotation of a heel part. In a first representation 608A, there is shown the Achilles tendon (represented by points 610A, 610B, 610C) of coronal axis of the foot, where the Achilles tendon (represented by an alignment of points 610A, 610B, 610C) is not in natural position, i.e., misaligned initially in the scanned 3D model of the foot. In other words, the Achilles tendon (represented by the alignment of the points 610A, 610B, 610C) is not parallel to the third straight line 506. Thus, the processor 206 is configured to rotate the heel part in a way that the Achilles tendon (represented by the alignment of the points 610A, 610B, 610C) is parallel to the third straight line 506 in the modified 3D model, as shown in a second representation 608B, in an example. In addition, the rotation and the translation of the heel part is parallel to the plane, such as the plane 402 of FIG. 4. Thus, the rotation of the heel part is used to re-align the initially obtained 3D model of the foot to obtain the modified 3D model of the foot that is very accurate and improves accuracy in fabrication of a custom shoe midsole and insole that in turn helps a subject to gain a natural position of the foot.

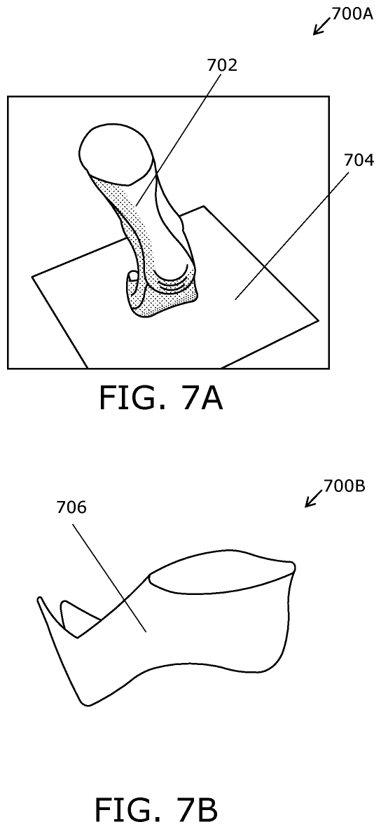

Referring to FIG. 7A and FIG. 7B, illustrated are exemplary diagrams that represents a creation of a three-dimensional (3D) model of a foot of a human subject, in accordance with different embodiments of the present disclosure. With reference to the FIG. 7A, there is shown an exemplary view 700A of a 3D model 702 of the foot obtained by scanning the foot, such as during an active phase of gait. There is also shown a ground surface 704. With reference to the FIG. 7B, there is shown an exemplary view 700B of a modified 3D model 706 of the foot that is modified to determine the natural position of the foot. Moreover, the modified 3D model 706 is created by rotating and translating the heel part in a way that the second straight line passes via the third point (i.e., a horizontal re-alignment). Moreover, the rotation and translation are parallel to the plane and the heel part is rotated in a way that the Achilles tendon is parallel to the third straight line (i.e., a vertical re-alignment).

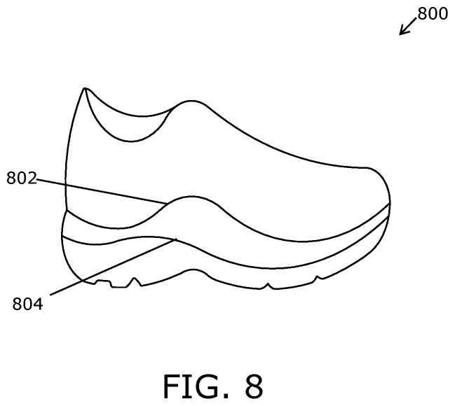

Referring to FIG. 8, illustrated is an exemplary diagram that represents an insole 802 that is manufactured by a modification of a three-dimensional (3D) model of a foot, in accordance with an embodiment of the present disclosure. The insole 802 is manufactured based on a modified 3D model of the natural position of the human subject. The insole 802 is located above a midsole 804, which is arranged on an outsole (or a bottom sole) of the shoe. Moreover, the insole 802 is manufactured by the modification of the 3D model of a foot to create a modified 3D model and to provide the re-alignment of the 3D model based on the accurate natural position of the foot of the human subject. In addition, the manufacturing of the insole according to the modified 3D model is used to provide comfort and support to the foot of the human subject to gain natural position of the foot.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of modifying a 3D model of a foot to create a modified 3D model, the method comprising
obtaining the 3D model of the foot;
identifying from the 3D model
a first point corresponding to a plantar head of 1. metatarsal,
a second point corresponding to a plantar head of 5. metatarsal,
a third point corresponding to a pternion;
an Achilles tendon center of coronal axis;
defining
a first straight line passing via the first point and the second point;
a second straight line perpendicular to the first straight line and passing via the second point, the second straight line-having direction parallel to a plane defined by the first point, the second point and the third point;
a third straight line being perpendicular to the plane and passing via the third point;
dividing the 3D model to a heel part and a toe part, wherein the heel part comprises from 30% up to 70% of the total foot in direction of the second straight line;
creating the modified 3D model by
rotating and translating the heel part in a way that the second straight line passes via the third point, wherein the rotation and translation is parallel to the plane, and
rotating the heel part in a way that the Achilles tendon is parallel to the third straight line.

2. A method according to claim 1, wherein the 3D model is captured by using any one of: a rotatable camera, a time-of-flight camera, an infra-red camera and an optical camera.

3. A method according to claim 1, wherein the obtaining of the 3D model of the foot comprises segregating the foot from a ground surface.

4. A method according to claim 1, wherein the identifying step from the 3D model further comprises identifying whether the 3D model is of a left foot or a right foot of a human subject.

5. A method according to claim 1, wherein the identifying step from the 3D model further comprises identifying a medial side and a lateral side of the foot.

6. A method according to claim 1, wherein the identifying step from the 3D model further comprises identifying a toe.

7. A method according to claim 1, wherein the identifying step from the 3D model further comprises identifying a medial malleolus portion and a lateral malleolus portion of the foot.

8. A method according to claim 1, wherein the identifying step from the 3D model further comprises identifying one or more metatarsal head joints of the foot.

9. A method according to claim 1, wherein the creating of the modified 3D model comprises modifying a lateral arch of the foot in such a way that the lateral arch is lowered towards a ground surface in a standing position of the foot when the foot has a concave lateral arch or a cavus foot.

10. A method of manufacturing an insole, wherein the insole is manufactured based on a modified 3D model, wherein the modified 3D model is created according to the method of claim 1.

11. A method of fabrication of a shoe midsole having a custom shape and a custom support profile, wherein the shoe midsole is fabricated based on a modified 3D model by using one of: an injection molding of ethylene vinyl acetate (EVA), three-dimensional (3D) printing or milling of midsole materials, wherein the modified 3D model is created according to the method of claim 1.

12. A system for modifying a 3D model of a foot to create a modified 3D model, the system comprising:
an image-capture device configured to capture a 3D model of the foot; and
a processor configured to:
obtain the 3D model of the foot from the image-capture device;
identify from the 3D model:
a first point corresponding to a plantar head of 1. metatarsal,
a second point corresponding to a plantar head of 5. metatarsal
a third point corresponding to a pternion;
an Achilles tendon center of coronal axis;
define:
a first straight line passing via the first point and the second point;
a second straight line perpendicular to the first straight line and passing via the second point, the second straight line having direction parallel to a plane defined by the first point, the second point and the third point;
a third straight line being perpendicular to the plane and passing via the third point;
divide the 3D model to a heel part and a toe part, wherein the heel part comprises from 30% up to 70% of the total foot in direction of the second straight line; and
create the modified 3D model by:
rotating and translating the heel part in a way that the second straight line passes via the third point, wherein the rotation and translation is parallel to the plane, and
rotating the heel part in a way that the Achilles tendon center of coronal axis is parallel to the third straight line.

13. A system according to claim 11, wherein the image-capture device is any one of: a rotatable camera, a time of flight camera, an infra-red camera and an optical camera.

14. A system according to the claim 11, wherein the identification of from the 3D model further comprises identifying a medial malleolus portion and a lateral malleolus portion of the foot.

15. A system according to claim 11, wherein the identification from the 3D model further comprises identifying one or more metatarsal head of the foot.

16. A system according to claim 11, wherein the creating of the modified 3D model comprises modifying a lateral arch of the foot in a way that the lateral arch is lowered towards a ground surface in a standing position of the foot when the foot is detected with a concave lateral arch or a cavus foot.
